(19) United States
(12) Patent Application Publication
(10) Pub. No.: US 2025/0184287 A1
(43) Pub. Date: Jun. 5, 2025

(54) ADAPTIVE PORT ROUTING NOTIFICATION

(71) Applicant: MELLANOX TECHNOLOGIES, LTD., Yokneam (IL)

(72) Inventors: Eran Gil Beracha, Tel Aviv (IL); Amit Kazimirsky, Tel Aviv (IL)

(21) Appl. No.: 18/524,624

(22) Filed: Nov. 30, 2023

(51) Int. Cl. H04L 49/111; H04L 45/00; H04L 49/60

(52) U.S. Cl. CPC H04L 49/111; H04L 45/38; H04L 49/602

(57) ABSTRACT

A device, communication system, and method are provided. In one example, a system for routing traffic is described that includes a plurality of ports to facilitate communication over a network. The system also includes a controller to selectively activate or deactivate ports of the system based on queue depths and additional information to improve power efficiency of the system.

### FIELD OF THE DISCLOSURE

The present disclosure is generally directed toward networking and, in particular, toward networking devices, switches, and methods of operating the same.

### BACKGROUND

Switches and similar network devices represent a core component of many communication, security, and computing networks. Switches are often used to connect multiple devices, device types, networks, and network types.

Devices including but not limited to personal computers, servers, or other types of computing devices, may be interconnected using network devices such as switches. These interconnected entities form a network that enables data communication and resource sharing among the nodes. Often, multiple potential paths for data flow may exist between any pair of devices. This feature, often referred to as multipath routing, allows data, often encapsulated in packets, to traverse different routes from a source device to a destination device. Such a network design enhances the robustness and flexibility of data communication, as it provides alternatives in case of path failure, congestion, or other adverse conditions. Moreover, it facilitates load balancing across the network, optimizing the overall network performance and efficiency. However, managing multipath routing and ensuring optimal path selection can pose significant challenges, necessitating advanced mechanisms and algorithms for network control and data routing, and power consumption may be unnecessarily high, particularly during periods of low traffic.

### BRIEF SUMMARY

In accordance with one or more embodiments described herein, a computing system, such as a switch, may enable a diverse range of systems, such as other switches, servers, personal computers, and other computing devices, to communicate across a network. Ports of the computing system may function as communication endpoints, allowing the computing system to manage multiple simultaneous network connections with one or more nodes.

Each port of the computing system may be considered a lane and have an egress queue of packets/data waiting to be sent via the port. In effect, each port may serve as an independent channel for data communication to and from the computing system. Ports allow for concurrent network communications, enabling the computing system to engage in multiple data exchanges with different network nodes simultaneously.

Traffic received by and/or sent from a port may be measured in terms of bandwidth, or a rate of data over time. For example, bandwidth for a port may be measured by tracking an amount of data sent or received by the port and determining a rate. As an example, bandwidth may be measured in terms of bits per second or in other terms.

As described herein, bandwidth may be monitored for either a system as a whole, considering all ingress and/or egress ports of the system, or for different ports of the system individually. If the bandwidth is less than a particular amount, the system may generate and transmit a notification to a source of traffic. The notification may cause the source to be less likely to continue sending the system traffic. As a result, a port of the system which previously received traffic from the source may cease receiving traffic from the source. In response to determining no traffic is being received (e.g., ceases), the port and/or the system as a whole may be deactivated.

The present disclosure describes systems and methods for enabling a switch or other computing system to potentially deactivate one or more ports in response to receiving a relatively low amount of traffic over a given period of time. Using such a system or method, an under-used switch in a network of switches may be shut down until needed, saving power. In some implementations, one or more ports of a switch may be individually deactivated, also resulting in power savings. Embodiments of the present disclosure aim to solve the above-noted shortcomings and other issues by implementing an improved routing approach. The routing approach depicted and described herein may be applied to a switch, a router, or any other suitable type of networking device known or yet to be developed.

In an illustrative example, a system for providing adaptive routing is disclosed that includes circuits to receive data from a network via a first port; determine a bandwidth; determine the bandwidth is below a threshold; generate an instruction packet in response to determining the bandwidth is below the threshold; and send the instruction packet via the first port.

In another example, a system for providing adaptive routing is disclosed that includes one or more circuits to receive data from a network; determine a total bandwidth associated with the received data; determine the total bandwidth associated with the received data is below a threshold; generate an instruction packet in response to determining the total bandwidth is below the threshold; and send the instruction packet via a plurality of ports.

In yet another example, a system for providing adaptive routing is disclosed that includes one or more circuits to receive data via a first port of a plurality of ports; determine a bandwidth associated with the received data; determine the bandwidth associated with the received data is below a threshold; generate an instruction packet in response to determining the bandwidth is below the threshold; and send the instruction packet via the first port.

Any of the above example aspects include wherein the bandwidth comprises a bandwidth of the first port, and wherein the one or more circuits are further to determine a second bandwidth associated with a second port.

Any of the above example aspects include wherein the bandwidth comprises a total bandwidth of a plurality of ports including the first port, and wherein determining the bandwidth comprises determining a total bandwidth for each of the plurality of ports.

Any of the above example aspects include wherein the bandwidth comprises an egress bandwidth, and the first port comprises an egress port.

Any of the above example aspects include wherein the one or more circuits are further to enter a sleep mode after a link is idle for a period of time.

Any of the above example aspects include wherein entering the sleep mode comprises disabling one or more serializer/deserializer (SerDes) circuits associated with the link.

Any of the above example aspects include wherein after sending the instruction packet, traffic at the first port ceases.

Any of the above example aspects include wherein a total network bandwidth is low relative to a total network capacity.

Any of the above example aspects include wherein the first port comprises a port of a spine switch, and wherein the data is received from a top-of-rack (TOR) switch.

Any of the above example aspects include wherein the first port comprises a port of an L2 switch, and wherein the data is received from an L3 switch, and wherein the data is forwarded to an L1 switch.

Any of the above example aspects include wherein the total bandwidth comprises a total egress bandwidth.

Any of the above example aspects include wherein sending the instruction packet comprises sending the packet to multiple destinations via the plurality of ports.

Any of the above example aspects include wherein the one or more circuits are further to enter a sleep mode after a link associated with the plurality of ports is idle for a period of time.

Any of the above example aspects include wherein entering the sleep mode comprises disabling one or more serializer/deserializer (SerDes) circuits associated with the link.

Any of the above example aspects include wherein after sending the instruction packet, traffic at the plurality of ports ceases.

Any of the above example aspects include wherein prior to determining the bandwidth associated with the first port, the one or more circuits are to select the first port using a selection process.

Any of the above example aspects include wherein the selection process comprises round-robin.

Any of the above example aspects include wherein the one or more circuits are further to select a second port using the selection process after sending the instruction packet.

Any of the above example aspects include wherein the one or more circuits are further to update a routing table based on the updated queue depth.

Additional features and advantages are described herein and will be apparent from the following Description and the figures.

### BRIEF DESCRIPTION OF THE SEVERAL VIEWS OF THE DRAWINGS

The present disclosure is described in conjunction with the appended figures, which are not necessarily drawn to scale:

FIG. 1 is a block diagram depicting an illustrative configuration of a computing system in accordance with at least some embodiments of the present disclosure;

FIG. 2 illustrates a network of a computing system and nodes in accordance with at least some embodiments of the present disclosure;

FIG. 3 illustrates a network of a computing system and nodes in accordance with at least some embodiments of the present disclosure;

FIG. 4 illustrates a network of computing systems and nodes in accordance with at least some embodiments of the present disclosure;

FIG. 5 is a flow diagram depicting a method in accordance with at least some embodiments of the present disclosure;

FIG. 6 is a flow diagram depicting a method in accordance with at least some embodiments of the present disclosure; and

FIG. 7 is a flow diagram depicting a method in accordance with at least some embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the described embodiments. It is understood that various changes may be made in the function and arrangement of elements without departing from the spirit and scope of the appended claims.

It will be appreciated from the following description, and for reasons of computational efficiency, that the components of the system can be arranged at any appropriate location within a distributed network of components without impacting the operation of the system.

Furthermore, it should be appreciated that the various links connecting the elements can be wired, traces, or wireless links, or any appropriate combination thereof, or any other appropriate known or later developed element(s) that is capable of supplying and/or communicating data to and from the connected elements. Transmission media used as links, for example, can be any appropriate carrier for electrical signals, including coaxial cables, copper wire and fiber optics, electrical traces on a printed circuit board (PCB), or the like.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means: A alone, B alone, C alone, A and B together, A and C together, B and C together, or A, B and C together.

The term “automatic” and variations thereof, as used herein, refers to any appropriate process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The terms “determine,” “calculate,” and “compute,” and variations thereof, as used herein, are used interchangeably, and include any appropriate type of methodology, process, operation, or technique.

Various aspects of the present disclosure will be described herein with reference to drawings that are schematic illustrations of idealized configurations.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and this disclosure.

As used herein, the singular forms “a,” “an,” and “the” are intended to include the plural forms as well, unless the context clearly indicates otherwise. It will be further understood that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items.

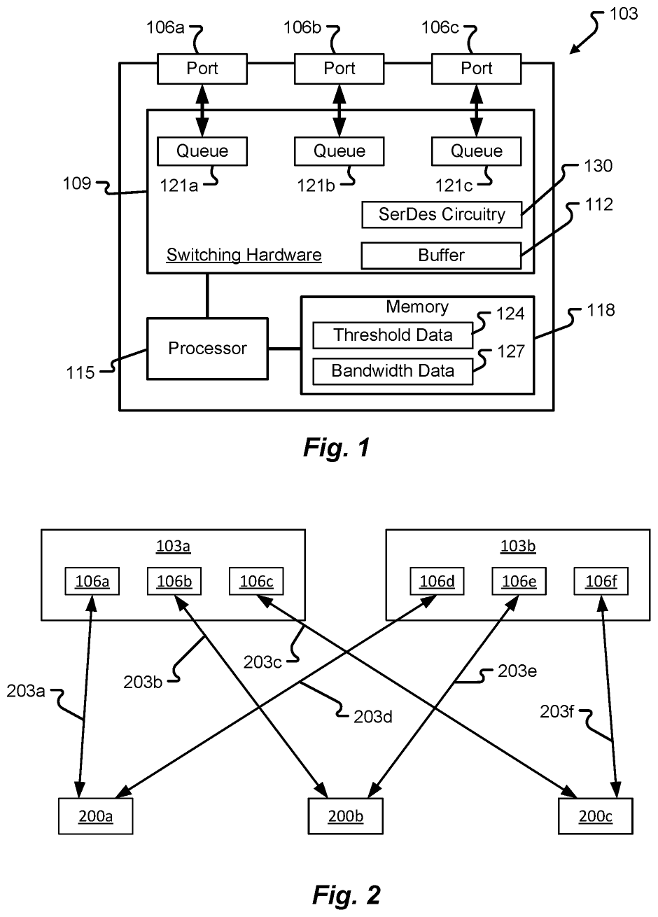

Referring now to FIGS. 1-7, various systems and methods for providing adaptive routing of packets between communication nodes will be described. The concepts of packet routing depicted and described herein can be applied to the routing of information from one computing device to another. The term packet as used herein should be construed to mean any suitable discrete amount of digitized information. The information being routed may be in the form of a single packet or multiple packets without departing from the scope of the present disclosure. Furthermore, certain embodiments will be described in connection with a system that is configured to make centralized routing decisions whereas other embodiments will be described in connection with a system that is configured to make distributed and possibly uncoordinated routing decisions. It should be appreciated that the features and functions of a centralized architecture may be applied or used in a distributed architecture or vice versa.

In accordance with one or more embodiments described herein, a computing system 103 as illustrated in FIG. 1 may enable a diverse range of systems, such as switches, servers, personal computers, and other computing devices, to communicate across a network. Such a computing system 103 as described herein may for example be a switch or any computing device comprising a plurality of ports 106 for connecting with nodes on a network. In some implementations, a computing system 103 as described herein may be a switch which connects multiple top-of-rack (TOR) switches. The switch may, for example, serve as a spine switch. In some implementations, a computing system 103 may be a part of a topology such as a 3-level fat tree topology. For example, a sending switch may be considered an L3 switch, a receiver switch may be considered an L2 switch, and a TOR switch may be considered an L1 switch. The computing system 103 may operate as any one of a spine, TOR, L1, L2, or L3 switch. Nodes as described herein which may send data to a computing system 103 may in some implementations include TOR switches, spine switches, or other computing devices capable of receiving and transmitting data.

The ports 106 of the computing system 103 may function as communication endpoints, allowing the computing system 103 to manage multiple simultaneous network connections with one or more nodes. As described above, the computing system 103 may be a spine switch or a TOR switch or may be one of an L1, L2, or an L3 switch in a three-level fat tree topology. Data received at a port 106 of a computing system 103 may be associated with a destination device with which the computing system 103 is either directly or indirectly connected. Upon receiving such data, the computing system 103 may be configured to process the data, determine a destination, and make a routing decision. Making a routing decision may comprise determining a port from which to forward the data. The destination may be directly connected to the computing system 103 via a single cable or may be indirectly connected to the computing system via one or more intermediary switches. Each port 106 may be used to transmit data associated with one or more flows. Each port 106a-c may be associated with a respective queue 121a-c enabling the port 106a-c to handle incoming and/or outgoing data packets associated with flows.

Each port 106 of the computing system may be considered a lane and be associated with an egress queue 121 of packets/data waiting to be sent via the port. In effect, each port 106 may serve as an independent channel for data communication to and from the computing system 103. Ports 106 may allow for concurrent network communications, enabling the computing system 103 to engage in multiple data exchanges with different network nodes simultaneously.

Each port 106a-c may be associated with an egress queue 121a-c which may store data, such as packets, waiting to be transmitted from the respective port 106a-d. As a packet or other form of data becomes ready to be sent from the computing system 103, the packet may be assigned to a port 106 from which the packet will be sent, and the packet may be stored in a queue 121 associated with the port.

In some implementations, each queue 121a-c may store packets received by a respective port 106a-c. For example, each port 106a-c may serve as an ingress port and may receive data from one or more sources. Upon receiving a packet, the packet data may be stored by the receiving port 106 in a respective queue 121.

Ports 106 of the computing system 103 may be physical connection points which allow network cables such as Ethernet cables to connect the computing system 103 to one or more network nodes. Each port 106 may be of a same or different type, including, for example, a 100 Mbps, 1000 Mbps, or 10-Gigabit Ethernet ports, each providing various levels of bandwidth.

As described herein, ports 106 may be deactivated based on a number of factors. Deactivating a port 106 may comprise, as described in greater detail below, reducing or turning off power to switching hardware 109 associated with the respective port 106. In some implementations, switching hardware 109 may be turned off on a port-by-port basis, or the switching hardware 109 for all ports may be turned off together. As described below, ports 106 may effectively be disabled as a result of not receiving traffic over a particular time period. As a result of disabling ports, the computing system 103 may reduce an amount of power consumption.

Switching hardware 109 of the computing system may comprise an internal fabric or pathway within the computing system 103 through which data travels between two ports 106. The switching hardware 109 may in some embodiments comprise one or more network interface cards (NICs). In some embodiments, each port 106a-d may be associated with a different NIC. The NIC or NICs may comprise hardware and/or circuitry which may be used to transfer data between ports 106.

Switching hardware 109 may also or alternatively comprise one or more application-specific integrated circuits (ASICs) to perform tasks such as determining to which port a received packet should be sent. The switching hardware 109 may comprise various components including, for example, port controllers that manage the operation of individual ports, NICs that facilitate data transmission, and internal data paths that direct the flow of data within the computing system 103. The switching hardware 109 may also include memory elements to temporarily store data and management software to control the operation of the hardware. This configuration may enable the switching hardware 109 to accurately track port usage and provide data to a processor 115 upon request.

Packets received by the computing system 103 may be placed in a buffer 112 until being placed in a queue 121 before being transmitted by a respective port 106. The buffer 112 may effectively be an ingress queue where received data packets may temporarily be stored. As described herein, the ports 106 via which a given packet is to be sent may be determined based on a number of factors.

In some implementations, the buffer 112 may store packet data and queues 121 may store packet-identifying data. Queues 121 as described herein may be data structures used to manage data to be forwarded by the computing system 103. Each port 106 of the computing system 103 may have an associated queue. When a packet is received by the computing system 103, the packet may first be written to the buffer 112 until the packet is assigned to a queue associated with a selected port to forward the packet.

The switching hardware 109 may include serializer/deserializer (SerDes) circuitry 130. Each port 106 may be associated with dedicated SerDes circuitry or may share SerDes circuitry 130. Disabling a port 106 may comprise disabling SerDes circuitry 130 associated with the port 106. Disabling SerDes circuitry 130 may include turning off or reducing an amount of power applied to the SerDes circuitry 130. As a result, disabling a port 106 may reduce power consumption of the computing system 103 as less power is consumed by the SerDes circuitry 130 while the port 106 is disabled.

As illustrated in FIG. 1, the computing system 103 may also comprise processing circuitry, referred to herein as processor 115, and may be a processor, a CPU, a microprocessor, or any circuit or device capable of reading instructions from memory 118 and performing actions. The processor 115 may, for example, execute software instructions to control operations of the computing system 103. The processor 115 may also write data to the memory 118.

The processor 115 may function as a central processing unit of the computing system 103 and may execute the functions enabling operative capabilities of the computing system 103. The processor 115 may be enabled to communicate with other components of the computing system 103 to manage and perform computational operations in accordance with systems and methods described herein.

The processor 115 may be programmed to perform a wide range of computational tasks. Capabilities of the processor 115 may include executing program instructions, managing data within the computing system 103, and controlling the operation of other hardware components of the computing system 103 such as switching hardware 109. The processor 115 may be a single-core or multi-core processor and might include one or more processing units, depending on the specific design and requirements of the computing system 103.

The computing system 103 may further comprise one or more memory 118 components. Memory 118 may be configured to communicate with the processor 115 of the computing system 103. Communication between memory 118 and the processor 115 may enable various operations, including but not limited to, data exchange, command execution, and memory management. In accordance with implementations described herein, memory 118 may be used to store data, such as threshold data 124 and bandwidth data 127, relating to usage of ports 106a-c of the computing system 103.

The memory 118 may be constituted by a variety of physical components, depending on specific type and design. For example, memory 118 may include one or more memory cells capable of storing data in the form of binary information. These memory cells may be made up of transistors, capacitors, or other suitable electronic components depending on the memory type, such as DRAM, SRAM, or Flash memory. To enable data transfer and communication with other parts of the computing system 103, memory 118 may also include or be in contact with one or more data lines or buses, address lines, and control lines.

Threshold data 124, as which may be stored in memory 118, may be a user-configurable variable which may be used to determine or detect when bandwidth of one or more ports is low. A threshold stored as threshold data 124 may be a percentage, a bit rate, a number of bits, or other format of data. A percentage threshold may be a percentage of a maximum bandwidth capability of one or more ports or may be a percentage of a number indicating a bandwidth less than a maximum bandwidth capability of one or more ports.

Bandwidth data 127 as which may be stored in memory 118 may be a record of port usage. For example, bandwidth data 127 may store a moving average bandwidth of each port 106a-c and/or an aggregated total moving average bandwidth of every port 106a-c or a subset of ports. In some implementations, historical data reflecting past bandwidths may be recorded as bandwidth data 127. For example, the processor 115 may record logs of bandwidth received via each port 106a-c with timestamps so that trends associated with usage of ports 106a-c may be identified or determined and future usage of ports 106a-c may be predicted based on identified trends.

In one or more embodiments of the present disclosure, a processor 115 of a computing system 103, such as a switch, may execute polling operations to retrieve data relating to activity of the ports 106a-d, such as by polling switching hardware 109. As used herein, polling may involve the processor 115 periodically querying or requesting data from the switching hardware 109. The polling process may encompass the processor 115 sending a request to the switching hardware 109 to retrieve desired data. Upon receiving the request, the switching hardware 109 may compile the requested port usage data and send it back to the processor 115.

Bandwidth data 127 may include various metrics such as amount of data or a number of packets in each queue 121a-c, an amount of data or a number of packets in the buffer 112, and/or other information, such as data transmission rates, error rates, and status of each port. The processor 115, after receiving this data, might perform further operations based on the obtained information such as determining moving averages of bandwidths, aggregating bandwidths of various ports 106a-c, comparing bandwidths to thresholds, and other functions as described herein.

In one or more embodiments of the present disclosure, a computing system 103, such as a switch, may be in communication with a plurality of network nodes 200a-c as illustrated in FIG. 2, forming a network. Each network node 200a-c may be a computing system with capabilities for sending and receiving data. Each node 200a-c may be any one of a broad range of devices, including but not limited to switches, personal computers, servers, or any other device capable of transmitting and receiving data in the form of packets. A node 200a-c may, for example, be a computing system 103 as illustrated in FIG. 1. Each node 200a-c may communicate with a plurality of computing systems 103, such as computing systems 103a and 103b as illustrated in FIG. 2. The nodes 200a-c and computing systems 103a-b may form a leaf-spine network, in which nodes 200a-c act as leaf switches and computing systems 103a-b act as spine switches. The limited number of nodes 200a-c and computing systems 103a-b illustrated in FIG. 2 should be considered as being for illustration purposes only and should not be considered as limiting in any way. For example, a network may include additional computing systems 103, more or fewer nodes 200a-c, and other computing devices at other levels, such as computing systems 103 which communicate with nodes 200a-c via computing systems 103a-b, or computing systems 103 which communicate with computing systems 103a-b via nodes 200a-c. Moreover, while every node 200a-c is illustrated as communicating directly with every computing system 103, it should be appreciated that other topologies and connection arrangements may be used.

Each computing system 103a-c may establish communication channels with network nodes 200a-c via ports. As illustrated in FIG. 2, computing system 103a communicates with node 200a via a channel 203a connected to port 106a, communicates with node 200b via a channel 203b connected to port 106b, and communicates with node 200c via a channel 203c connected to port 106c. Similarly, computing system 103b communicates with node 200a via a channel 203d connected to port 106d, communicates with node 200b via a channel 203e connected to port 106e, and communicates with node 200c via a channel 203f connected to port 106f. Such channels may support data transfer in the form of flows of packets, following predetermined protocols that govern the format, size, transmission method, and other aspects of the packets.

Each network node 200a-c may interact with each computing system 103a-b in various ways. A node 200 may send data packets to a computing system 103 for processing, transmission, or other operations, or for forwarding to another node 200 or another computing system 103. Conversely, each node 200 may receive data from the computing system 103, originating from either the computing system 103 itself or other network nodes 200a-c or other computing systems 103 via the computing system 103. In this way, the computing systems 103a-b and nodes 200a-c collectively form a network, facilitating data exchange, resource sharing, and other collaborative operations.

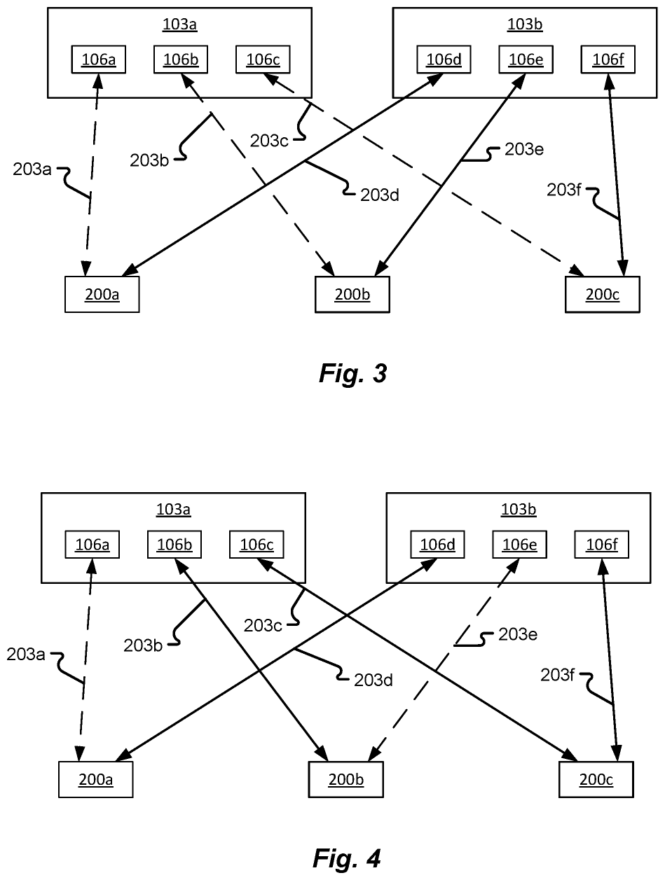

As illustrated in FIGS. 3 and 4, communication via channels 203a-f may be active or inactive based on routing decisions made by nodes 200a-c and/or computing systems 103a-b. When a port 106a-f of a computing system 103a-b does not receive (or transmit) data for a period of time, the port 106a-f may be selectively disabled. In the example illustrated in FIG. 3, communication channels 203a-c are inactive (represented by dashed lines). As a result, each of ports 106a-c may be disabled by computing system 103a. In the example illustrated in FIG. 4, communication channels 203a and 203e are inactive. As a result, port 106a may be disabled by computing system 103a and port 106e may be disabled by computing system 103b.

When a port 106 is disabled, electronics associated with the port, such as SerDes circuitry 130, may be powered off. As a result, when ports 106 are disabled, the computing system 103 may consume reduced or no power. When every port 106 of a computing system 103 are disabled, such as ports 106a-c of computing system 103a illustrated in FIG. 3, the computing system 103 may enter a sleep mode, be shut down, or otherwise be enabled to consume reduced or no power. Using a system or method as described herein, computing systems 103, such as switches, may be enabled to reduce power consumption by sending adaptive routing notification packets to nodes 200 when ports 106 are determined to be underused. In response to such notification packets, nodes 200 may be configured to reroute packets if possible. As a result, traffic across multiple ports 106 and computing systems 103 may be consolidated and underused ports can be avoided so that the ports 106 may be disabled to reduce power.

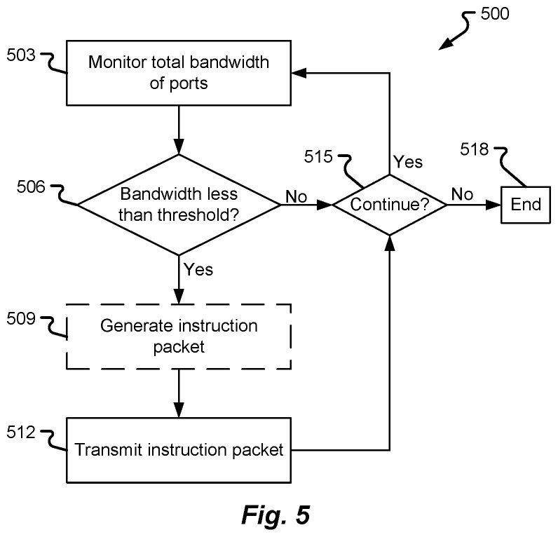

The scenarios illustrated in FIGS. 3 and 4 may be a result of adaptive routing notification packets generated by computing system 103a and sent to each of nodes 200a-c. The adaptive routing notification packets may be generated by the computing system 103a as a result of a determination that traffic received by each of ports 106a-c is below a threshold. An adaptive routing notification packet generated by computing system 103a may effectively communicate to a node 200 which receives the adaptive routing notification packet that the computing system 103a is experiencing congestion, while the computing system 103a is in reality experiencing the opposite of congestion. As a result of receiving such an adaptive routing notification packet, a node 200 may, if possible, reroute traffic to avoid the computing system 103a. The node 200 may be programmed to avoid or resolve congestion at computing systems 103 by rerouting traffic in response to adaptive routing notification packets; however, by using a system or method as described herein, the nodes 200 will aid the computing systems 103 in reducing power consumption by rerouting traffic from lesser used ports 106. This technological advancement may be achieved through the performance of one or more methods 500, 600, 700 as illustrated in FIGS. 5-7 and as described below.

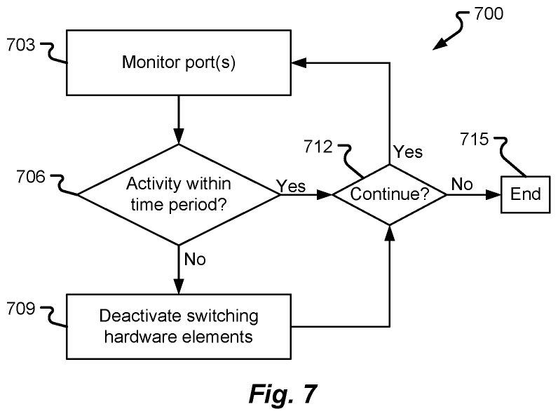

FIG. 3 illustrates an example implementation in which a computing system 103a determines a total bandwidth of an aggregate of the bandwidths of traffic received at each of ports 106a-c is below an aggregate bandwidth threshold. In response to such a determination, the computing system 103a has sent adaptive routing notification packets to each of nodes 200a-c and has ceased receiving traffic from each of nodes 200a-c. After not receiving traffic from nodes 200a-c for a period of time, the computing system 103a has disabled ports 106a-c, entered a sleep mode, or otherwise reduced an amount of power consumption. This implementation may be as illustrated by the method 500 of FIG. 5 and method 700 of FIG. 7 and as described below.

As illustrated in FIG. 5, and in accordance with a computing system 103 as illustrated in FIG. 1 and as described herein, a method 500 may be performed to enable a computing system 103, in the event of receiving relatively low traffic across a plurality of ports, to instruct nodes sending data to the computing system 103 to reroute, or be more likely to reroute, traffic away from the computing system 103. As a result, the computing system 103 may reduce power consumption by shutting down or reducing power to switching hardware and/or other power-consuming elements associated with the ports. While the description of the method 500 provided herein describes the steps of the method 500 as being performed by a processor 115 of the computing system 103, the steps of the method 500 may be performed by one or more processors 115, switching hardware 109, one or more controllers in the computing system 103, or some combination thereof.

At 503, the computing system 103 may monitor a total bandwidth of all ports 106 or a subset of ports of the computing system 103. Monitoring the total bandwidth may comprise, in some implementations, monitoring an individual bandwidth of each of a plurality of ports and aggregating the individual bandwidths to calculate a total bandwidth. Monitoring bandwidth of one or more ports may be performed in any one or more of a number of ways, such as by counting packets and/or bytes sent from each port within a particular timeframe, measuring a rate of packets sent, e.g., packets per second or bits per second, over a particular timeframe, monitoring a length of one or more queues associated with one or more ports, using flow analysis mechanisms, traffic sampling mechanisms, monitoring an amount of data in one or more shared buffers serving multiple ports, or any other conceivable manner of tracking a bandwidth of ports. The bandwidth monitored may be an ingress bandwidth or may be an egress bandwidth.

At 506, the computing system 103 may determine whether the total bandwidth is less than a threshold. The threshold may be a user-configurable datapoint stored in memory 118 of the computing system 103. The threshold may represent a number of bits, a number of packets, a rate of bits, a rate of packets, or another quantifiable metric. Determining whether the total bandwidth is less than a threshold may be performed periodically at a particular rate, such as once every 10 milliseconds for example, or constantly.

Throughout this document, various comparisons are made regarding the state of bandwidth in relation to a predetermined threshold. It should be appreciated that any reference to a determination of whether a variable is “less than” a threshold may additionally or alternatively include “less than or equal to” the threshold. Similarly, for determinations of whether a variable is “less than or equal to” a threshold, it should be understood that such a determination may also or alternatively be made based solely on whether the variable is “less than” the threshold. This interpretation also applies to determinations of variables being “greater than” or “greater than or equal to” a threshold.

In some implementations, the total bandwidth threshold may be set by a user or system administrator while in other implementations the total bandwidth threshold may be automatically set by the computing system 103 such as by calculating the total bandwidth threshold. Calculating the total bandwidth threshold may in some implementations involve determining a network topology, determining a number of spine switches in the network, or otherwise making determinations relating to possible alternative routes for traffic.

In some implementations, a total bandwidth threshold may be directly or indirectly related to the network topology, number of spine switches in the network, or other network design considerations. A threshold as described herein may relate or depend at least in part on an overall bandwidth, a total network capacity, or an amount of traffic across a network of computing systems. For example, the method 500 may require the total bandwidth to be lower than a relatively low threshold before shutting down switching hardware of the computing system 103 when a network of which the computing system 103 is a component is occupied with relatively high overall bandwidth. Similarly, the method 500 may require the total bandwidth only to be lower than a relatively high threshold before shutting down switching hardware of the computing system 103 when a network of which the computing system 103 is a component is occupied with relatively low overall bandwidth.

The method 500 may be useful in a scenario in which a total network bandwidth, including bandwidth across a plurality of spine switches, is low relative to a total network capacity of the network. When a total network bandwidth is low relative to a total network capacity of the network, consolidating the flow of traffic by reducing the number of active but under-used ports can be used to provide a reduction in overall power consumption for the network without affecting performance.

At 509, if the total bandwidth is less than the threshold, the computing system 103 may generate an instruction packet, such as an adaptive routing notification packet. Generating the instruction packet may be an optional step. For example, no generation of an instruction packet may be required and the computing system 103 may be enabled to transmit an instruction packet without requiring generating the instruction packet. An instruction packet may comprise information which may be capable of being used by a node 200 to consider rerouting traffic.

In some implementations, the computing system 103 may be configured to send instruction packets at a particular maximum rate, such as a limit of one instruction packet per port per second for example, though it should be appreciated that in some implementations no such limit may be required.

At 512, the computing system may transmit the instruction packet via each of the ports 106. Transmitting the instruction packet may comprise sending the instruction packet as part of an acknowledgment or reply to a packet received from a port 106. Transmitting may also or alternatively not be in response to any particular packet and may instead be performed without requiring any prompt from a source node.

If, at 506, a determination is instead made that the total bandwidth is greater than or equal to the bandwidth threshold, the method 500 may include determining whether the method 500 should continue at 515 and either ending at 518 or returning to the monitoring step 503 described above. The method 500 may be performed constantly during operation of the computing system or may run based on particular schedules and/or applications. For example, certain applications may require maximum performance while sacrificing power efficiency and when such applications are executed, the computing system may end power efficiency methods such as the method 500.

At any point, before, during, or after the above-discussed method 500, the processor may also perform a method 700, as described in greater detail below, in which switching hardware and/or other power-consuming elements of the computing system 103 may be shut down, entered into a sleep mode, or otherwise operated in a low-power mode when no traffic is received, either via a particular port or by the computing system 103 as a whole.

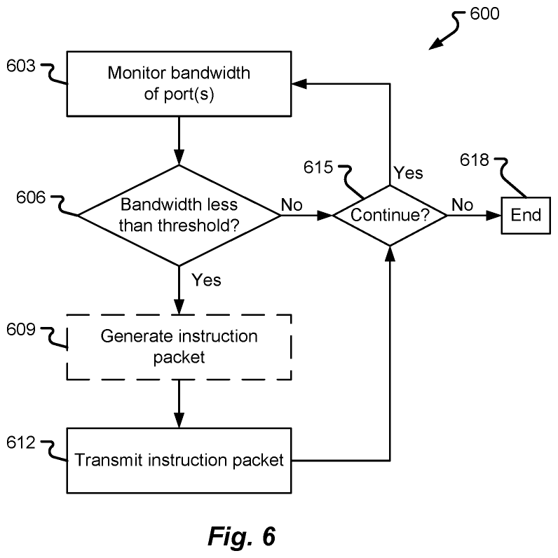

FIG. 4, as described above, illustrates an example implementation in which a first computing system 103a determines a bandwidth of traffic received at port 106a is below a per-port bandwidth threshold and a second computing system 103b determines a bandwidth of traffic received at port 106e is below a per-port bandwidth threshold. In response to such determinations, computing system 103a has sent an adaptive routing notification packet to node 200a and computing system 103b has sent an adaptive routing notification packet to node 200b. After sending the adaptive routing notifications, computing system 103a has ceased receiving traffic from node 200a and computing system 103b has ceased receiving traffic from node 200e. After not receiving traffic from node 200a for a period of time, the computing system 103a has disabled port 106a or otherwise reduced an amount of power consumption. After not receiving traffic from node 200b for a period of time, the computing system 103b has disabled port 106e or otherwise reduced an amount of power consumption. This implementation may be as illustrated by the method 600 of FIG. 6 and method 700 of FIG. 7 and as described below.

As illustrated in FIG. 6, and in accordance with a computing system 103 as illustrated in FIG. 1 and as described herein, a method 600 may be performed to enable a computing system 103, in the event of receiving relatively low traffic via a particular port, to instruct nodes sending data to the computing system 103 to reroute, or be more likely to reroute, traffic away from the computing system 103. As a result, the computing system 103 may reduce power consumption by shutting down or reducing power to switching hardware and/or other power-consuming elements associated with the particular port. While the description of the method 600 provided herein describes the steps of the method 600 as being performed by a processor 115 of the computing system 103, the steps of the method 600 may be performed by one or more processors 115, switching hardware 109, one or more controllers in the computing system 103, or some combination thereof. The method 600 of FIG. 6, as described below, may be performed separately for each port among a plurality of ports. For example, the method 600 may be performed in parallel for each port or may be performed in series for each port.

At 603, the computing system 103 may monitor a bandwidth of each of one or more ports 106 of the computing system 103. Monitoring bandwidth of one or more ports may be performed in any one or more of a number of ways, such as by counting packets and/or bytes sent from each port within a particular timeframe, measuring a rate of packets sent, e.g., packets per second or bits per second, over a particular timeframe, monitoring a length of one or more queues associated with one or more ports, using flow analysis mechanisms, traffic sampling mechanisms, monitoring an amount of data in one or more shared buffers serving multiple ports, or any other conceivable manner of tracking a bandwidth of ports. The bandwidth monitored may be an ingress bandwidth or may be an egress bandwidth.

At 606, the computing system 103 may determine whether the bandwidth of any port is less than a threshold. The threshold may be a user-configurable datapoint stored in memory 118 of the computing system 103. The threshold may represent a number of bits, a number of packets, a rate of bits, a rate of packets, or another quantifiable metric. Determining whether the bandwidth of any particular port is less than a threshold may be performed periodically at a particular rate, such as once every 10 milliseconds for example, or constantly.

In some implementations, the per-port bandwidth threshold may be set by a user or system administrator while in other implementations the per-port bandwidth threshold may be automatically set by the computing system 103 such as by calculating the per-port bandwidth threshold. Calculating the per-port bandwidth threshold may in some implementations involve determining a network topology, determining a number of spine switches in the network, or otherwise making determinations relating to possible alternative routes for traffic. For example, a per-port bandwidth threshold may be directly or indirectly related to the network topology, number of spine switches in the network, or other network design considerations. In some implementations, a threshold as described herein may relate or depend at least in part on an overall bandwidth or an amount of traffic across a network of computing systems, or a total bandwidth of each of the ports of the computing system 103. For example, the method 600 may require the per-port bandwidth for a port to be lower than a relatively low threshold before shutting down switching hardware associated with the port when a network of which the computing system 103 is a component is occupied with relatively high overall bandwidth or when the ports of the computing system 103 are, in total, occupied with relatively high bandwidth. Similarly, the method 600 may require a per-port bandwidth for a port only to be lower than a relatively high threshold before shutting down switching hardware associated with the port when a network of which the computing system 103 is a component is occupied with relatively low overall bandwidth or when the ports of the computing system 103 are, in total, occupied with relatively low bandwidth.

At 609, if the bandwidth of a port is less than the threshold, the computing system 103 may generate an instruction packet, such as an adaptive routing notification packet. Generating the instruction packet may be an optional step. For example, no generation of an instruction packet may be required and the computing system 103 may be enabled to transmit an instruction packet without requiring generating the instruction packet. An instruction packet may comprise information which may be capable of being used by a node 200 to consider rerouting traffic.

In some implementations, the computing system 103 may be configured to send instruction packets at a particular maximum rate, such as a limit of one instruction packet per port per second for example, though it should be appreciated that in some implementations no such limit may be required.

At 612, the computing system may transmit the instruction packet via the port 106 for which the bandwidth is less than the threshold. Transmitting the instruction packet may comprise sending the instruction packet as part of an acknowledgment or reply to a packet received from the port 106. Transmitting may also or alternatively not be in response to any particular packet and may instead be performed without requiring any prompt from a source node.

If, at 606, a determination is instead made that the individual bandwidths of each of the ports are greater than or equal to the bandwidth threshold, the method 600 may include determining whether the method 600 should continue at 615 and either ending at 618 or returning to the monitoring step 603 described above. The method 600 may be performed constantly during operation of the computing system or may run based on particular schedules and/or applications. For example, certain applications may require maximum performance while sacrificing power efficiency and when such applications are executed, the computing system may end power efficiency methods such as the method 600.

In some implementations, the method 600 may be performed for one port at a time. At the beginning of the method 600, the computing system 103 may select a first port for which to determine if the bandwidth is less than the threshold. After making the determination at 606 (and transmitting an instruction packet at 612 if the bandwidth for the first port is less than the threshold), the computing system 103 may select a second port for which to determine if the bandwidth is less than the threshold.

In some implementations, selecting the second port may involve using round-robin or another selection protocol or algorithm. For example, in at least one implementation, at the beginning of the method 700, the computing system 103 may activate a round-robin iterator. The round-robin iterator may be a software or hardware algorithm designed to generate and maintain a sequential order of the identifiers. A dynamic pointer may be used to select a first port for which to monitor bandwidth. After determining whether the bandwidth for the first port is less than the threshold, the pointer may advance to a next port. With each progressive iteration, the pointer may advance to a subsequent port. Once each of the ports have been monitored, the pointer may return to the first port and the cycle may continue.

At any point, before, during, or after the above-discussed method 600, the processor may also perform a method 700, as described in greater detail below, in which switching hardware and/or other power-consuming elements of the computing system 103 may be shut down, entered into a sleep mode, or otherwise operated in a low-power mode when no traffic is received, either via a particular port or by the computing system 103 as a whole.

FIG. 7 shows an example method 700 of deactivating switching hardware elements as a result of detecting no activity at one or more ports for a particular time period. The method may begin at 703, in which a computing system 103 may monitor usage of one or more ports of the computing system 103. Monitoring ports may in some implementations comprise tracking an amount of data sent and/or received from a port, monitoring data in one or more queues associated with a port, or otherwise tracking port usage. The monitoring of ports may be performed by a processor of the computing system 103 or by dedicated or multi-use circuitry.

At 706, a determination may be made as to whether any activity on a port occurs within a time period. The computing system 103 may constantly monitor each port separately in parallel or may consecutively check for usage of each port in a series. The computing system 103 may be enabled to determine whether over a particular previous amount of time any data has been sent and/or received by each port. The amount of time may differ depending on configuration settings and may be set either by a user or administrator or by the computing system 103 automatically.

If for any particular port no data is detected as being sent and/or received for the particular previous amount of time, the computing system 103 may, at 709, deactivate one or more switching hardware elements for the particular port. Deactivating switching hardware elements may comprise deactivating one or more SerDes circuits or other circuitry which consumes power while idle. For example, one or more circuitry or circuitry associated with a port or with packet forwarding may consume power even which not actively participating in packet forwarding. While the power consumed by such hardware elements when idle may be less than or equal to power consumed by such hardware elements when actively participating in packet forwarding, the power consumed may not be negligible. By deactivating such hardware elements, the computing system 103 may be enabled to reduce power consumption when the ports associated with such circuits or circuitry are not in use. By deactivating hardware elements as described herein, a reduction in power consumption can be achieved. In some implementations, a computing system 103 may be enabled to enter ports into a sleep mode or otherwise reduce power consumption relating to ports for which no data is detected as being sent and/or received for a particular amount of time. If all ports of the computing system 103 are deactivated, the computing system 103 may enter a sleep mode as well or shut down.

If no particular port is detected as not sending and/or receiving data for the particular previous amount of time at 706, or after deactivating the switching hardware elements at 709, the method 700 may comprise, at 712, determine whether to continue. The method 700 may be performed constantly during operation of the computing system or may run based on particular schedules and/or applications. For example, certain applications may require maximum performance while sacrificing power efficiency and when such applications are executed, the computing system may end power efficiency methods such as the method 700.

If the computing system 103 determines to continue the method 700, the method 700 may comprise returning to monitoring the one or more ports at 703. If instead the computing system 103 determines not to continue the method 700, the method 700 may end at 715.

The present disclosure encompasses methods with fewer than all of the steps identified in FIGS. 5-7 (and the corresponding descriptions of the methods), as well as methods that include additional steps beyond those identified in FIGS. 5-7 (and the corresponding description of the methods). The present disclosure also encompasses methods that comprise one or more steps from the methods described herein, and one or more steps from any other method described herein.

Embodiments of the present disclosure include a system for providing adaptive routing, the system comprising one or more circuits to: receive data from a network via a first port; determine a bandwidth; determine the bandwidth is below a threshold; generate an instruction packet in response to determining the bandwidth is below the threshold; and send the instruction packet via the first port.

Aspects of the above system include wherein the bandwidth comprises a bandwidth of the first port, and wherein the one or more circuits are further to determine a second bandwidth associated with a second port.

Aspects of the above system include wherein the bandwidth comprises a total bandwidth of a plurality of ports including the first port, and wherein determining the bandwidth comprises determining a total bandwidth for each of the plurality of ports.

Aspects of the above system include wherein the bandwidth comprises an egress bandwidth, and the first port comprises an egress port.

Aspects of the above system include wherein the one or more circuits are further to enter a sleep mode after a link is idle for a period of time.

Aspects of the above system include wherein entering the sleep mode comprises disabling one or more serializer/deserializer (SerDes) circuits associated with the link.

Aspects of the above system include wherein after sending the instruction packet, traffic at the first port ceases.

Aspects of the above system include wherein a total network bandwidth is low relative to a total network capacity.

Aspects of the above system include wherein the first port comprises a port of a spine switch, and wherein the data is received from a top-of-rack (TOR) switch.

Aspects of the above system include wherein the first port comprises a port of an L2 switch, and wherein the data is received from an L3 switch, and wherein the data is forwarded to an L1 switch.

Embodiments of the present disclosure also include a system for providing adaptive routing, the system comprising one or more circuits to: receive data from a network; determine a total bandwidth associated with the received data; determine the total bandwidth associated with the received data is below a threshold; generate an instruction packet in response to determining the total bandwidth is below the threshold; and send the instruction packet via a plurality of ports.

Aspects of the above system include wherein the total bandwidth comprises a total egress bandwidth.

Aspects of the above system include wherein sending the instruction packet comprises sending the packet to multiple destinations via the plurality of ports.

Aspects of the above system include wherein the one or more circuits are further to enter a sleep mode after a link associated with the plurality of ports is idle for a period of time.

Aspects of the above system include wherein entering the sleep mode comprises disabling one or more serializer/deserializer (SerDes) circuits associated with the link.

Aspects of the above system include wherein after sending the instruction packet, traffic at the plurality of ports ceases. Embodiments of the present disclosure also include a system for providing adaptive routing, the system comprising one or more circuits to: receive data via a first port of a plurality of ports; determine a bandwidth associated with the received data; determine the bandwidth associated with the received data is below a threshold; generate an instruction packet in response to determining the bandwidth is below the threshold; and send the instruction packet via the first port.

Aspects of the above system include wherein prior to determining the bandwidth associated with the first port, the one or more circuits are to select the first port using a selection process.

Aspects of the above system include wherein the selection process comprises round-robin.

Aspects of the above system include wherein the one or more circuits are further to select a second port using the selection process after sending the instruction packet.

It is to be appreciated that any feature described herein can be claimed in combination with any other feature(s) as described herein, regardless of whether the features come from the same described embodiment.

Specific details were given in the description to provide a thorough understanding of the embodiments. However, it will be understood by one of ordinary skill in the art that the embodiments may be practiced without these specific details. In other instances, well-known circuits, processes, algorithms, structures, and techniques may be shown without unnecessary detail in order to avoid obscuring the embodiments.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A system for providing adaptive routing, the system comprising one or more circuits to:
receive data from a network via a first port;
determine a bandwidth;
determine the bandwidth is below a threshold;
generate an instruction packet in response to determining the bandwidth is below the threshold; and
send the instruction packet via the first port.

2. The system of claim 1, wherein the bandwidth comprises a bandwidth of the first port, and wherein the one or more circuits are further to determine a second bandwidth associated with a second port.

3. The system of claim 1, wherein the bandwidth comprises a total bandwidth of a plurality of ports including the first port, and wherein determining the bandwidth comprises determining a total bandwidth for each of the plurality of ports.

4. The system of claim 1, wherein the bandwidth comprises an egress bandwidth, and the first port comprises an egress port.

5. The system of claim 1, wherein the one or more circuits are further to enter a sleep mode after a link is idle for a period of time.

6. The system of claim 5, wherein entering the sleep mode comprises disabling one or more serializer/deserializer (SerDes) circuits associated with the link.

7. The system of claim 1, wherein after sending the instruction packet, traffic at the first port ceases.

8. The system of claim 7, wherein a total network bandwidth is low relative to a total network capacity.

9. The system of claim 1, wherein the first port comprises a port of a spine switch, and wherein the data is received from a top-of-rack (TOR) switch.

10. The system of claim 1, wherein the first port comprises a port of an L2 switch, and wherein the data is received from an L3 switch, and wherein the data is forwarded to an L1 switch.

11. A system for providing adaptive routing, the system comprising one or more circuits to:
receive data from a network;
determine a total bandwidth associated with the received data;
determine the total bandwidth associated with the received data is below a threshold;
generate an instruction packet in response to determining the total bandwidth is below the threshold; and
send the instruction packet via a plurality of ports.

12. The system of claim 11, wherein the total bandwidth comprises a total egress bandwidth.

13. The system of claim 11, wherein sending the instruction packet comprises sending the instruction packet to multiple destinations via the plurality of ports.

14. The system of claim 11, wherein the one or more circuits are further to enter a sleep mode after a link associated with the plurality of ports is idle for a period of time.

15. The system of claim 14, wherein entering the sleep mode comprises disabling one or more serializer/deserializer (SerDes) circuits associated with the link.

16. The system of claim 11, wherein after sending the instruction packet, traffic at the plurality of ports ceases.

17. A system for providing adaptive routing, the system comprising one or more circuits to:
receive data via a first port of a plurality of ports;
determine a bandwidth associated with the received data;
determine the bandwidth associated with the received data is below a threshold;
generate an instruction packet in response to determining the bandwidth is below the threshold; and
send the instruction packet via the first port.

18. The system of claim 17, wherein prior to determining the bandwidth associated with the first port, the one or more circuits are to select the first port using a selection process.

19. The system of claim 18, wherein the selection process comprises round-robin.

20. The system of claim 18, wherein the one or more circuits are further to select a second port using the selection process after sending the instruction packet.
